(19) United States
(12) Patent Application Publication
(10) Pub. No.: US 2013/0222365 A1
(43) Pub. Date: Aug. 29, 2013

(54) APPARATUS AND METHOD FOR DISPLAYING IMAGE ON 3-DIMENSIONAL DISPLAY BASED ON MULTI-LAYER PARALLAX BARRIER

(71) Applicants: Hyun LEE, Daejeon-si (KR); Eung Don LEE, Daejeon-si (KR)

(72) Inventors: Hyun LEE, Daejeon-si (KR); Eung Don LEE, Daejeon-si (KR)

(73) Assignee: Electronics and Telecommunications Research Institute, Daejeon (KR)

(21) Appl. No.: 13/562,661

(22) Filed: Jul. 31, 2012

(30) Foreign Application Priority Data
Feb. 27, 2012 (KR) 10-2012-0019806

(51) Int. Cl. G06T 15/00

(52) U.S. Cl. 345/419

(57) ABSTRACT

An apparatus and method for displaying an image on a 3D image display device based on a multi-layer parallax barrier are provided. The method includes: measuring a position of a viewer based on the display device; determining whether or not parallax barrier switching is required based on the measurement results; and when parallax barrier switching is determined to be required in the determination, outputting a 2D image through the 3D display device from a point in time at which the parallax barrier switching starts to a point in time at which the parallax barrier switching ends, wherein the 3D image is an image in which a left image and a right image is distributedly disposed in the same frame, and the 2D image is an image in which only any one of the left image and the right image is disposed in the same frame.

### CROSS-REFERENCE TO RELATED APPLICATIONS

This application claims the benefit of priority of Korean Patent Application No. 10-2012-0019806 filed on Feb. 27, 2012, all of which is incorporated by reference in its entirety herein.

### BACKGROUND OF THE INVENTION

1. Field of the Invention

The present invention relates to a 3D display method and, more particularly, to a switching method in a 3D display based on a multi-layer parallax barrier.

2. Related Art

Recently, three-dimensional (3D) image broadcasting has come to prominence. 3D image broadcasting is, for example, a method of transmitting two images viewed by a user's (or a viewer's) left and right eyes and allowing the respective eyes to view different images through polarizing eyeglasses, time division type eyeglasses, or the like, which provides an effect as if the user views a 3D stereoscopic image.

The foregoing 3D image broadcasting, however, is disadvantageous in that the viewer should use a tool such as polarizing eyeglasses. Thus, as one of methods for overcoming such shortcomings, there is provided a method of using a 3D display device based on a multi-layer parallax barrier not requiring a tool such as polarizing eyeglasses.

FIG. 1 shows an example of a 3D display device based on a multi-layer parallax barrier. With reference to FIG. 1, the 3D display device spatially divides a left image (L) seen to the viewer's left eye and a right image (R) seen to the viewer's right eye to display the same on an LCD panel. A multi-layer parallax bather is coupled to the LCD panel. Among the multi-layer parallax bather, only a barrier corresponding to a viewing distance of the viewer is driven by a barrier controller and a driving circuit, and the other remaining barriers are turned off. The viewing distance of the viewer is measured by a measurement unit. According to this scheme, the viewer can view the left image through his left eye and the right image through his right eye, obtaining the effect of a stereoscopic image.

However, in the related art, ON/OFF switching of a parallax barrier occurs frequently according to a change in a position of the viewer, and in a particular position, the left and right of a stereoscopic image are interchanged to be seen, so in order to view a normal stereoscopic image, left/right image switching should be performed to reverse the left and right images. Namely, parallax barrier switching and left/right image switching should be simultaneously performed. In this case, however, a left/right image reversal phenomenon in which the left and right images are changed to be seen due to a liquid crystal (LC) reaction delay time of the parallax barrier may occur. In addition, a crosstalk phenomenon in which left and right images are seen to both eyes due to an influence of a difference in the LC reaction rates between two switched parallax barriers may occur, or a phenomenon in which a stereoscopic image flickers because both the left and right images are not instantaneously seen may occur.

Thus, a method for settling the foregoing problems in a 3D display device based on a multi-layer parallax barrier is required.

### SUMMARY OF THE INVENTION

In a 3D display device based on a multi-layer parallax barrier, parallax barrier switching and left/right image switching are necessarily performed according to a change in a position of a viewer. Here, left and right images are interchanged to be seen according to a liquid crystal (LC) reaction of the parallax barrier, a crosstalk phenomenon occurs, and image flickering occurs. The present invention provides an image display method for settling the foregoing problems in a 3D display device based on a multi-layer parallax barrier to minimize user inconvenience in viewing a stereoscopic image, and a 3D display device employing the same.

In an aspect, a method for displaying an image on a 3D image display device based on a multi-layer parallax barrier is provided. The method for displaying an image on a 3D image display device based on a multi-layer parallax barrier, includes: measuring a position of a viewer based on the display device; determining whether or not parallax barrier switching is required based on the measurement results; and when parallax barrier switching is determined to be required in the determination, outputting a 2D image through the 3D display device from a point in time at which the parallax barrier switching starts to a point in time at which the parallax barrier ends, wherein the 3D image is an image in which a left image and a right image is distributedly disposed in the same frame, and the 2D image is an image in which only any one of the left image and the right image is disposed in the same frame.

When it is determined that the parallax barrier switching is not required in the determination, the 3D image may be output.

In another aspect, a method for displaying an image on a 3D image display device based on a multi-layer parallax barrier is provided. The method for displaying an image on a 3D image display device based on a multi-layer parallax barrier, includes: measuring a position of a viewer based on the display device; determining whether or not parallax barrier switching is required based on the measurement results; when parallax barrier switching is determined to be required in the determination, increasing a frame rate of an output image output through the display device by an integer multiple; periodically inserting a black image in the output image having the increased frame rate; and performing parallax barrier switching at a point in time at which the inserted black image is output to the display device.

The 3D image may be an image in which a left image and a right image are distributedly disposed in the same frame.

The black image may be an image including only single image data.

The black image may be an image including only single image data with respect to a partial time region in the same frame.

In another aspect, an apparatus for displaying an image on a 3D image display device based on a multi-layer parallax barrier is provided. The apparatus for displaying an image on a 3D image display device based on a multi-layer parallax barrier may include: a measurement unit measuring a position of a viewer; an image output unit dispersing a left image and a right image in a single frame and displaying the same; a parallax barrier blocking a portion of an image displayed on the image output unit; and an image and barrier controller controlling parallax barrier switching and an image displayed on the image output unit based on the measurement results of the measurement unit, wherein when parallax barrier switching is determined to be required, the image and barrier controller outputs a 2D image through the image output unit from a point in time at which the parallax barrier switching starts to a point in time at which the parallax barrier switching ends, and wherein the 3D image is an image in which a left image and a right image is distributedly disposed in the same frame, and the 2D image is an image in which only any one of the left image and the right image is disposed in the same frame.

When the image and barrier controller determines that parallax barrier switching is not required, the image and barrier controller may output the 3D image through the image output unit.

In another aspect, an apparatus for displaying an image on a 3D image display device based on a multi-layer parallax barrier is provided. The apparatus for displaying an image on a 3D image display device based on a multi-layer parallax barrier may include: a measurement unit measuring a position of a viewer; an image output unit dispersing a left image and a right image in a single frame and displaying the same; a parallax barrier blocking a portion of an image displayed on the image output unit; and an image and barrier controller controlling parallax barrier switching and an image displayed on the image output unit based on the measurement results of the measurement unit, wherein when parallax barrier switching is determined to be required, the image and barrier controller increases a frame rate of an output image output though the image output unit by an integer multiple, periodically inserts a black image in an output image of the increased frame rate, and performs parallax barrier switching at a point in time when the inserted black image is output from the image output unit.

The 3D image may be an image in which a left image and a right image are distributedly disposed in the same frame.

The black image may be an image including only single image data.

The black image may be an image including only single image data with respect to a partial time region in the same frame.

### BRIEF DESCRIPTION OF THE DRAWINGS

FIG. 1 is a diagram showing an example of a 3D display device based on a multi-layer parallax barrier.

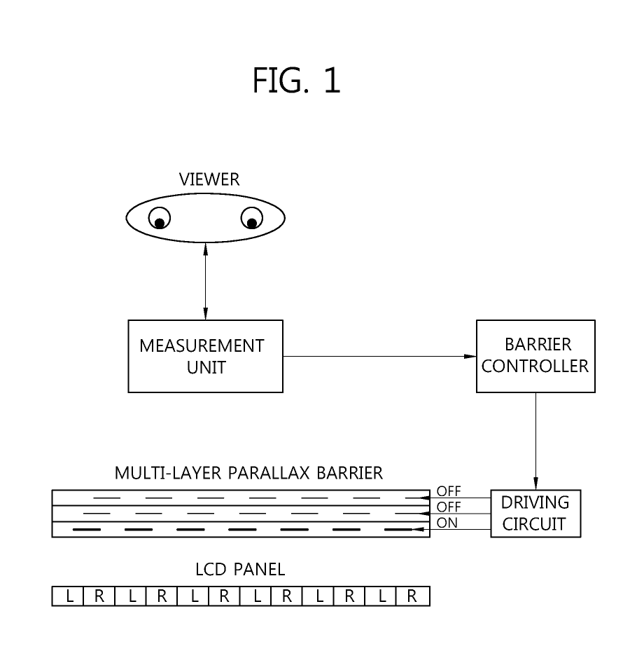

FIG. 2 is a diagram showing a phenomenon in which left and right images are reversed due to an LC reaction relay time of a parallax barrier in the 3D display device based on a multi-layer parallax barrier.

FIG. 3 is a diagram showing an image flickering phenomenon and a crosstalk phenomenon due to a difference in LC reaction rates of parallax barriers when parallax barrier switching occurs in a 3D display based on a multi-layer parallax barrier.

FIG. 4 is a diagram showing a phenomenon that may appear on an image frame when a viewing position of a viewer viewing a 3D display based on a multi-layer parallax barrier is changed.

FIG. 5 is a diagram showing a 3D display device based on a multi-layer parallax barrier according to an embodiment of the present invention.

FIG. 6 is a flow chart illustrating an operation process of a display device according to an embodiment of the present invention.

FIG. 7 is a diagram showing an image frame displayed on an image output unit based on the method illustrated in FIG. 6.

FIG. 8 is a flow chart illustrating an operation process of a display device according to another embodiment of the present invention.

FIG. 9 is a diagram showing an image frame displayed on an image output unit based on the method illustrated in FIG. 8.

### DESCRIPTION OF EXEMPLARY EMBODIMENTS

To begin with, problems that may arise in a 3D display based on a multi-layer parallax barrier will be mentioned, and embodiment of the present invention for solving the problems will be described.

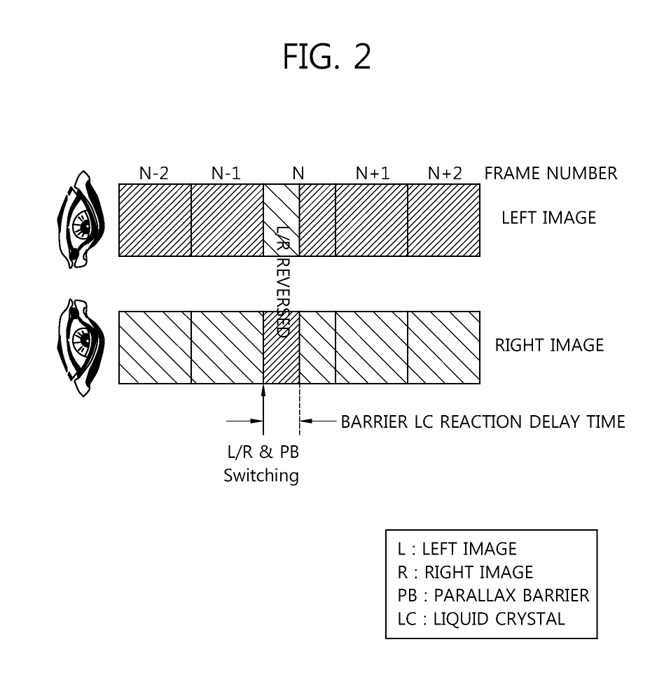

FIG. 2 is a diagram showing a phenomenon in which left and right images are reversed due to an LCD reaction relay time of a parallax barrier in the 3D display device based on a multi-layer parallax barrier.

Namely, FIG. 2 shows an influence of a liquid crystal (LC) reaction delay time of a parallax barrier when parallax barrier switching and a left/right image switching simultaneously occur due to a change in a viewing position of a viewer.

Here, parallax barrier switching refers to switching a parallax barrier from an ON state to an OFF state or from an OFF state to an ON state, and left/right image switching refers to changing the position of a left image oriented toward the viewer's left eye and that of a right image oriented toward the viewer's right eye.

When parallax barrier switching and the left/right image switching are performed in synchronization with a frame clock, a left image and a right image are interchanged in positions so as to be reproduced. In this case, however, a time is taken for LC of the parallax barrier to react (i.e., the LC of the parallax barrier reacts with delay). When it is assumed that an LC reaction delay time of two parallax barriers is equal, the left and right images are interchanged to be seen as shown in FIG. 2 during a period of time until when parallax barrier switching is completely performed.

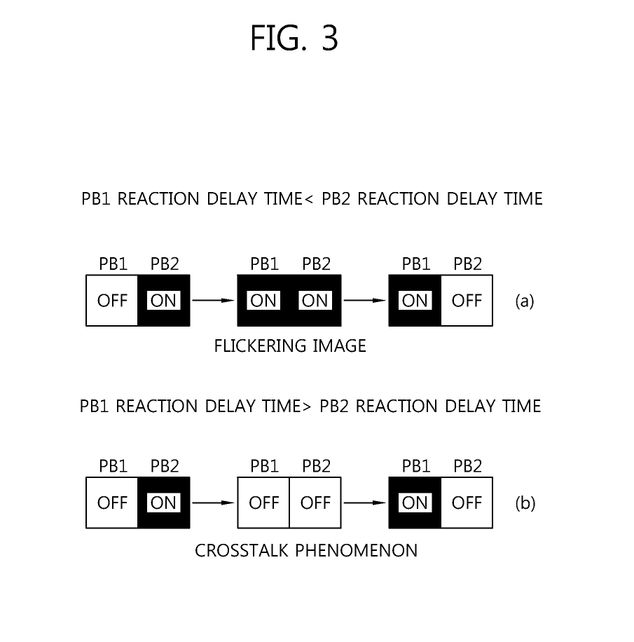

FIG. 3 is a diagram showing an image flickering phenomenon and a crosstalk phenomenon due to a difference in LC reaction rates of parallax barriers when parallax barrier switching occurs in a 3D display based on a multi-layer parallax barrier.

With reference to FIG. 3(a), in a state in which a parallax barrier 1 (PB 1) is in an OFF state (i.e., a state in which light is transmitted therethrough) and a parallax barrier 2 (PB2) is in an ON state (i.e., a state in which light is blocked), when the two parallax barriers are switched, if a reaction rate of the PB 1 is higher than that of the PB2, the two parallax barriers are turned on during a period of time corresponding to a difference between the reaction rates of the two parallax barriers. Then, light emitted from an LCD panel is entirely blocked, making the left and right images invisible, causing a stereoscopic image to flicker.

Referring to FIG. 3(b), when the reaction rate of the PB 1 is lower than that of the PB2, both of the two parallax barriers are turned off during a period of time corresponding to a difference between the reaction rates of the two parallax barriers, allowing light emitted from the LCD panel to be entirely transmitted therethrough. Then, a cross talk phenomenon in which the left and right images are seen to both eyes occurs.

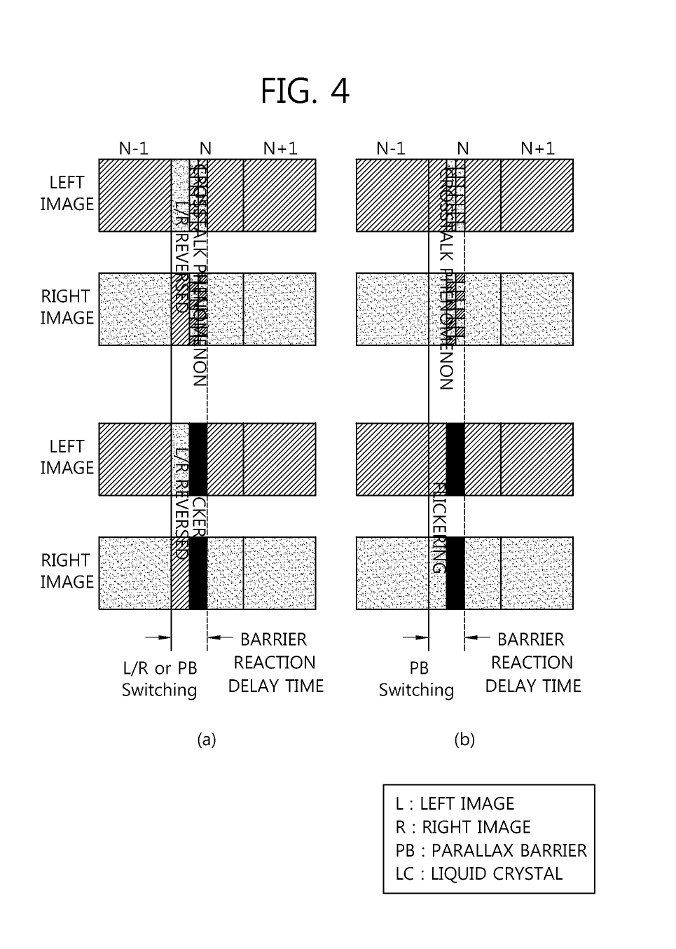

FIG. 4 is a diagram showing a phenomenon that may appear on an image frame when a viewing position of a viewer viewing a 3D display based on a multi-layer parallax barrier is changed.

With reference to FIG. 4(a), when parallax barrier switching and left/right image switching occur simultaneously, a flickering phenomenon in which the left and right images are reversed to be seen and then both the left and right eyes are seen to both eyes during a short period of time or the left and right images are reversed to be seen and then neither of the left and right eyes are seen during a short period of time may occur due to a difference between the LCD reaction delay time and the LC reaction speed of the two parallax barriers.

With reference to FIG. 4(b), when only parallax barrier switching occurs, a phenomenon in which a flickering phenomenon in which both the left and right images are seen to both eyes or neither of them are seen during a short period of time may occur due to a difference in the LC reaction rates of the two parallax barriers.

Namely, when the viewing position of the viewer viewing a 3D display based on a multi-layer parallax barrier is changed, as shown in FIG. 4, the left/right image reversal phenomenon, the cross talk phenomenon, the flickering phenomenon appear in conjunction, which are unpleasant to the eyes or cause fatigue or make the viewer feel dizzy when the viewer views stereoscopic images for a long period of time.

Thus, one of solutions includes a method of accurately measuring an LC reaction delay time when the parallax barrier is turned on or off and turning on or off the parallax barrier in advance by the LC reaction delay time in switching the parallax barrier. However, the LC reaction delay time may slightly differ according to a parallax barrier process and an LC reaction delay time may slightly differ according to positions in a single LCD, so the method of turning on or off the parallax barrier in advance in consideration of the LC reaction delay time requires a significantly precise parallax barrier process.

Hereinafter, a 3D display device based on a multi-layer parallax barrier and a method of operating the same according to an embodiment of the present invention will be described

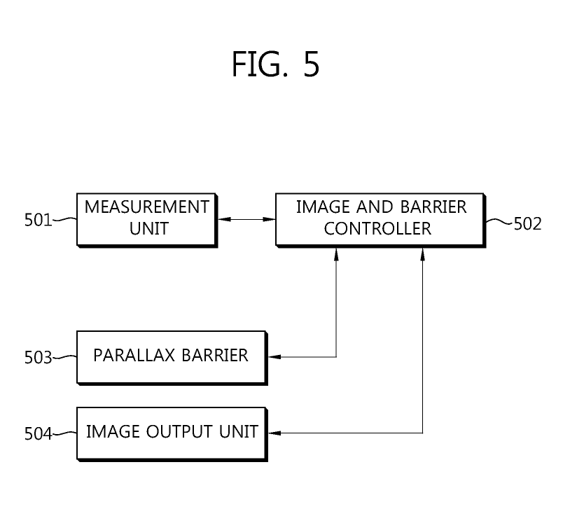

FIG. 5 is a diagram showing a 3D display device based on a multi-layer parallax barrier according to an embodiment of the present invention.

Referring to FIG. 5, the 3D display device based on a multi-layer parallax barrier includes a measurement unit 501, an image and barrier controller 502, a parallax barrier 503, and an image output unit 504.

The measurement unit 501 is a unit for measuring a distance between a viewer and the display device and left and right positions of the viewer, a tilt of the face, and the like. In order to measure a distance between the viewer and the display device and left and right positions of the viewer, the measurement unit 501 may utilize a measurement sensor and a camera. For example, the measurement unit 501 may use an IR sensor, an ultrasonic sensor, a laser sensor, a 2D camera, a stereoscopic camera, or the like.

The parallax barrier 503 may include a plurality of layers. Only a parallax barrier 503 of a particular layer among the plurality of layers may be turned on while the parallax barrier 503 of the other remaining layers may be turned off according to a control signal input from the image and barrier controller 502.

The image output unit 504, a unit for displaying an image, may be configured as an LCD panel. The image output unit 504 may distributedly dispose a left image viewed by the viewer's left eye and a right image viewed by the viewer's right eye and display the same. The image output unit 504 may display both the left and right images or any one of the left and right images within the same frame according to a control signal from the image and barrier controller 502. Also, the image output unit 504 may increase a frame rate of an image to be displayed according to the control signal from the image and barrier controller 502 by an integer multiple, and periodically insert a black image into some of the increased frames. Here, the black image refers to an image including only single image data. For example, the black image refers to an image displayed in black.

The image and barrier controller 502 is a unit for controlling the parallax barrier 503 and the image output unit 504. Namely, the image and barrier controller 502 removes a flickering phenomenon, a cross talk phenomenon, a left/right image reversal phenomenon of an image, or the like, upon being operated according to a method as described hereinafter.

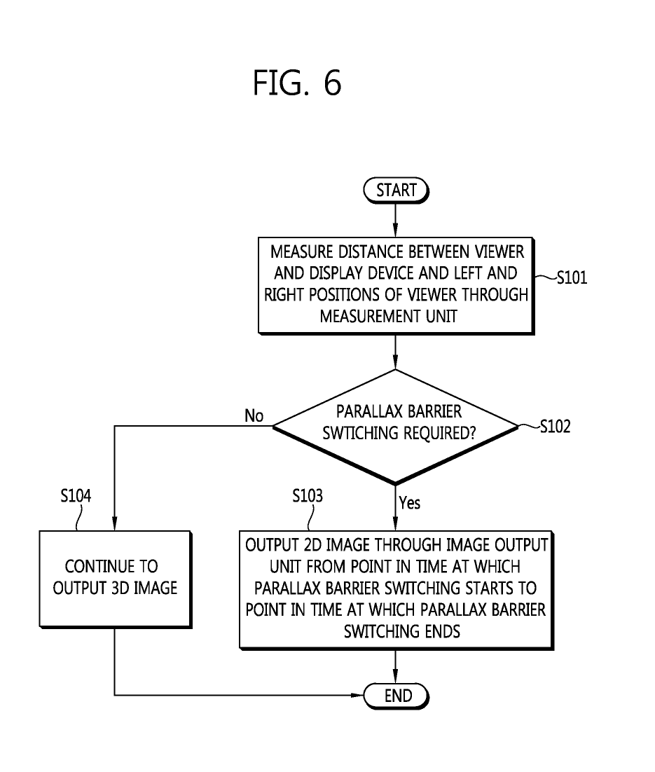

FIG. 6 is a flow chart illustrating an operation process of a display device according to an embodiment of the present invention.

With reference to FIG. 6, the display device measures a distance between the viewer and the display device through the measurement unit 501 (S 101).

The image and barrier controller 502 determines whether or not parallax barrier 503 switching is required based on the distance between the viewer and the display device and the left and right positions of the viewer measured by the measurement unit 501 (S 102).

When it is determined that parallax barrier 503 switching is required according to the determination results, the image and barrier controller 502 outputs a 2D image through the image output unit 504 from a point in time at which parallax barrier 503 switching starts to a point in time at which parallax barrier 503 switching ends (S 103). Here, the 2D image refers to an image that a right image viewed by the viewer's right eye and a left image viewed by the viewer's left eye are the same. In other words, the image and barrier controller 502 provides control to output 2D image, rather than a 3D image during the parallax barrier 503 switching time. From a viewpoint of the viewer, only the left image (or the right image) is seen to the viewer's both eyes from the point in time at which the parallax barrier 503 switching starts to the point in time at which parallax barrier 503 switching ends.

When it is determined that parallax barrier 503 switching is not required according to the determination results, the image and barrier controller 502 continues to output a 3D image (S 104).

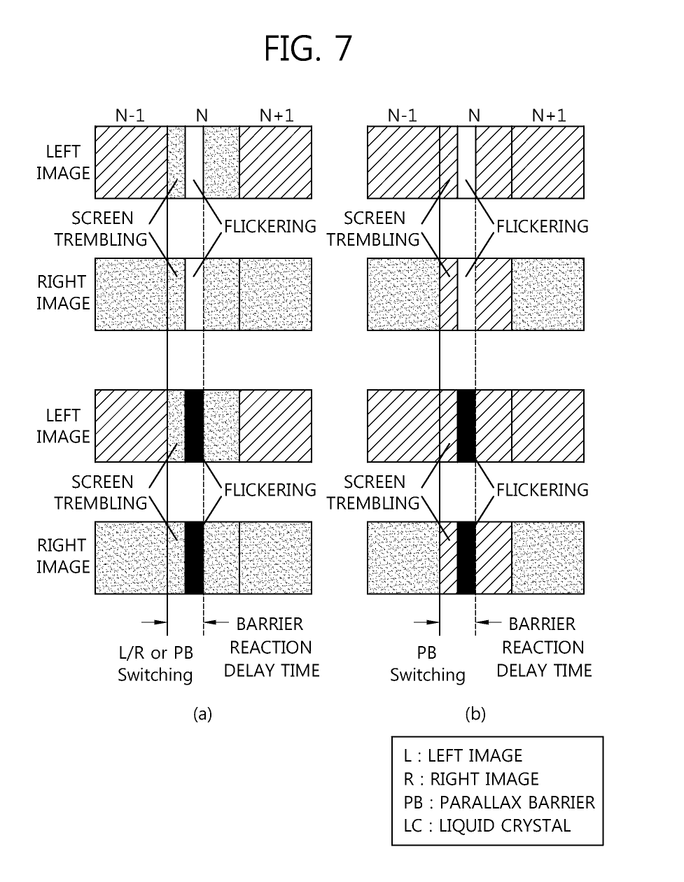

FIG. 7 is a diagram showing an image frame displayed on the image output unit 504 based on the method illustrated in FIG. 6.

In the related art, when parallax barrier switching and left/right image switching simultaneously occur, the cross talk phenomenon or flickering phenomenon may occur together with the left/right image reversal phenomenon, and when only parallax barrier switching occurs, the cross talk phenomenon or flickering phenomenon may occur.

In comparison, according to the method described above with reference to FIG. 6, a stereoscopic image is changed into a 2D image such that only the left image or the right image is seen to both eyes during a period of time from a point in time at which parallax barrier switching starts to a point in time at which the parallax barrier switching ends. Thus, the left/right image reversal phenomenon or the cross talk phenomenon can be eliminated. Of course, even in the method according to an embodiment of the present invention, a screen trembling phenomenon may occur when a stereoscopic image is instantly changed into a 2D image and a flickering phenomenon may occur due to a change in screen brightness generated as two parallax barriers are simultaneously turned on or off. However, since the left/right image reversal phenomenon and the cross talk phenomenon are eliminated, viewer inconvenience when the viewer views a stereoscopic image can be drastically reduced.

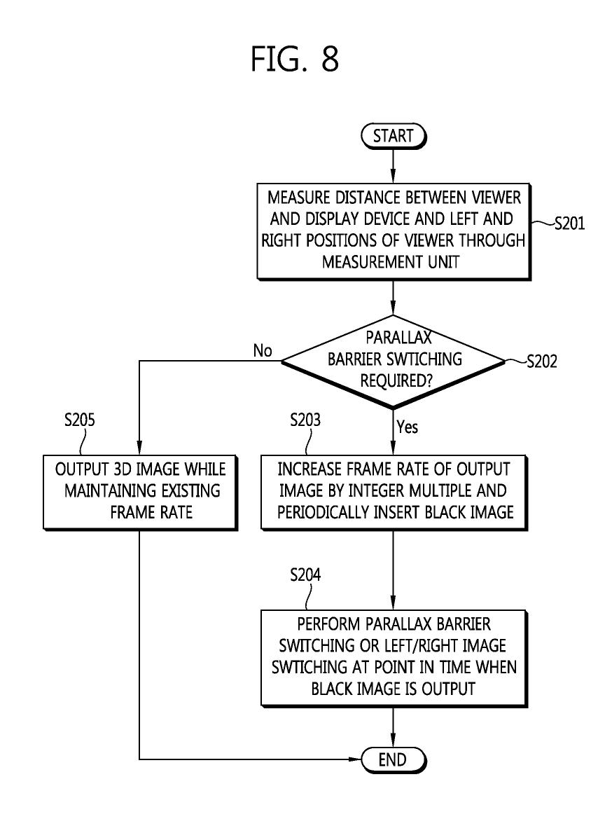

FIG. 8 is a flow chart illustrating an operation process of a display device according to another embodiment of the present invention.

With reference to FIG. 8, the display device measures a distance between the viewer and the display device through the measurement unit 501 (S201).

The image and barrier controller 502 determines whether or not parallax barrier 503 switching is required based on the distance between the viewer and the display device and the left and right positions of the viewer measured by the measurement unit 501 (S202).

When it is determined that parallax barrier 503 switching is required according to the determination results, the image and barrier controller 502 increases a frame rate of an image output through the image output unit 504 by an integer multiple, and then, periodically inserts a black image (S203). As described above, the black image refers to an image displaying only single image data, e.g., an image in black color. The black image may be an image including only single image data with respect to a partial time region in the same frame.

The image and barrier controller 502 performs parallax barrier 503 switching or left/right image switching at a point in time when the black image is output (S204).

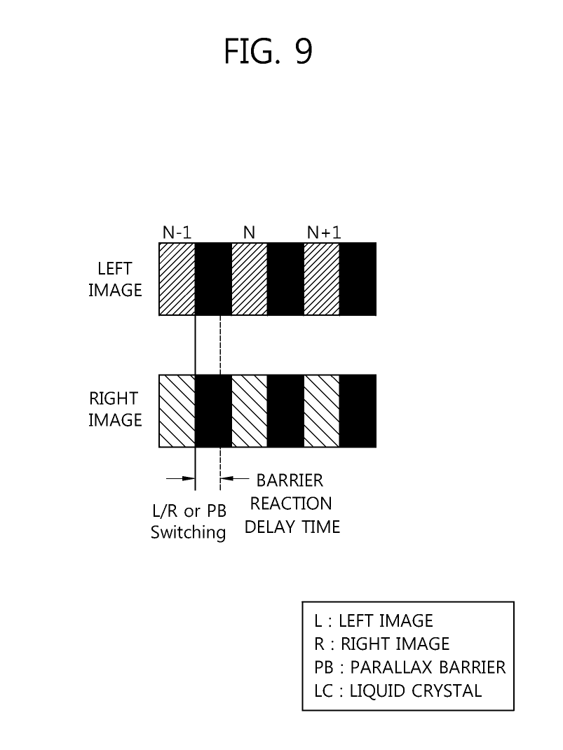

FIG. 9 is a diagram showing an image frame displayed on an image output unit based on the method illustrated in FIG. 8.

With reference to FIG. 9, a black image is output while parallax barrier switching or left/right image switching is performed in frames N−1, N, and N+1. According to this method, all of the left/right image reversal phenomenon, the cross talk phenomenon, and the flickering phenomenon due to a change in screen brightness can be eliminated. The reason is because a black image is output in the parallax barrier switching or the left/right image switching section in which the left/right image reversal phenomenon, the cross talk phenomenon, or the flickering phenomenon due to a change in screen brightness occurs. Of course, since the black image is output during a certain period of time of the image frames, screen brightness may be degraded. However, in the foregoing case in which the black image is periodically inserted, brightness of a backlight may be increased to uniformly maintain screen brightness.

According to embodiments of the present invention, an image flickering phenomenon, a crosstalk phenomenon, and a phenomenon in which left and right images are reversed can be reduced in a 3D display device based on a multi-layer parallax barrier. Thus, a more comfortable viewing environment can be provided to viewers in viewing 3D images.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

What is claimed is:

1. A method for displaying an image on a 3D image display device based on a multi-layer parallax barrier, the method comprising:
measuring a position of a viewer based on the display device;
determining whether or not parallax barrier switching is required based on the measurement results; and
when parallax barrier switching is determined to be required in the determination, outputting a 2D image through the 3D display device from a point in time at which the parallax barrier switching starts to a point in time at which the parallax barrier switching ends,
wherein the 3D image is an image in which a left image and a right image is distributedly disposed in the same frame, and the 2D image is an image in which only any one of the left image and the right image is disposed in the same frame.

2. The method of claim 1, wherein when it is determined that the parallax barrier switching is not required in the determination, the 3D image is output.

3. A method for displaying an image on a 3D image display device based on a multi-layer parallax barrier, the method comprising:
measuring a position of a viewer based on the display device;
determining whether or not parallax barrier switching is required based on the measurement results;
when parallax barrier switching is determined to be required in the determination, increasing a frame rate of an output image output through the display device by an integer multiple;
periodically inserting a black image in the output image having the increased frame rate; and
performing parallax barrier switching at a point in time at which the inserted black image is output to the display device.

4. The method of claim 3, wherein the 3D image is an image in which a left image and a right image are distributedly disposed in the same frame.

5. The method of claim 4, wherein the black image is an image including only single image data.

6. The method of claim 5, wherein the black image is an image including only single image data with respect to a partial time region in the same frame.

7. An apparatus for displaying an image on a 3D image display device based on a multi-layer parallax barrier, the apparatus comprising:
a measurement unit measuring a position of a viewer;
an image output unit dispersing a left image and a right image in a single frame and displaying the same;
a parallax barrier blocking a portion of an image displayed on the image output unit; and
an image and barrier controller controlling parallax barrier switching and an image displayed on the image output unit based on the measurement results of the measurement unit,
wherein when parallax barrier switching is determined to be required, the image and barrier controller outputs a 2D image through the image output unit from a point in time at which the parallax barrier switching starts to a point in time at which the parallax barrier switching ends, and
wherein the 3D image is an image in which a left image and a right image is distributedly disposed in the same frame, and the 2D image is an image in which only any one of the left image and the right image is disposed in the same frame.

8. The apparatus of claim 7, wherein when the image and barrier controller determines that parallax barrier switching is not required, the image and barrier controller outputs the 3D image through the image output unit.

9. An apparatus for displaying an image on a 3D image display device based on a multi-layer parallax barrier, the apparatus comprising:
a measurement unit measuring a position of a viewer;
an image output unit dispersing a left image and a right image in a single frame and displaying the same;
a parallax barrier blocking a portion of an image displayed on the image output unit; and
an image and barrier controller controlling parallax barrier switching and an image displayed on the image output unit based on the measurement results of the measurement unit,
wherein when parallax barrier switching is determined to be required, the image and barrier controller increases a frame rate of an output image output though the image output unit by an integer multiple, periodically inserts a black image in an output image of the increased frame rate, and performs parallax barrier switching at a point in time when the inserted black image is output from the image output unit.

10. The apparatus of claim 9, wherein the 3D image is an image in which a left image and a right image are distributedly disposed in the same frame.

11. The apparatus of claim 10, wherein the black image is an image including only single image data.

12. The apparatus of claim 11, wherein the black image is an image including only single image data with respect to a partial time region in the same frame.
